(19) United States
(12) Patent Application Publication
(10) Pub. No.: US 2017/0072467 A1
(43) Pub. Date: Mar. 16, 2017

(54) FABRICATION OF BASE PLATE, FABRICATION OF ENCLOSURE, AND FABRICATION OF SUPPORT POSTS IN ADDITIVE MANUFACTURING

(71) Applicant: Applied Materials, Inc., Santa Clara, CA (US)

(72) Inventors: Raanan Zehavi, Cupertino, CA (US); Hou T. Ng, Campbell, CA (US); Nag B. Patibandla, Pleasanton, CA (US)

(73) Assignee: Applied Materials, Inc., Santa Clara, CA (US)

(21) Appl. No.: 15/268,176

(22) Filed: Sep. 16, 2016

Related U.S. Application Data
(60) Provisional application No. 62/219,605, filed on Sep. 16, 2015.
(60) Provisional application No. 62/263,388, filed on Dec. 4, 2015.

(51) Int. Cl. B22F 3/105; B33Y 30/00; B33Y 10/00

(52) U.S. Cl. CPC B22F 3/1055; B33Y 10/00; B33Y 30/00; B22F 2003/1056; B22F 2003/1058; B22F 2003/1059

(57) ABSTRACT

An apparatus for forming an object includes a platform and a dispensing system overlying the platform to dispense successive layers of powder. The successive layers include support layers and object layers on the support layers. The apparatus further includes an energy source to fuse the powder. A controller is configured to cause the energy source to fuse a support region of each of the support layers to form a part support base. The controller is further configured to cause the energy source to fuse an enclosure region of each of the object layers to form an enclosure dividing each of the object layers into an inner region and outer region. The controller is also configured to cause the energy source to fuse an object portion of the inner region of each of the object layers. A parallel projection of the object defines a part area contained within the inner region.

### CROSS-REFERENCE TO RELATED APPLICATIONS

This application claims priority to U.S. Provisional Application Ser. No. 62/263,388, filed on Dec. 4, 2015 and claims priority to U.S. Provisional Application Ser. No. 62/219,605, filed Sep. 16, 2015, the entirety of the contents of each being incorporated by reference.

### TECHNICAL FIELD

This specification relates to additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic or metal).

A variety of additive processes can be used in additive manufacturing. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g. stereolithography (SLA). These processes can differ in the way layers are formed to create the finished objects and in the materials that are compatible for use in the processes.

Conventional systems use an energy source for sintering or melting a powdered material. Once all the selected locations on the first layer are sintered or melted and then re-solidified, a new layer of powdered material is deposited on top of the completed layer, and the process is repeated layer by layer until the desired object is produced.

### SUMMARY

In one aspect, an additive manufacturing apparatus for forming an object includes a platform and a dispensing system overlying the platform to dispense successive layers of powder over a top surface of the platform. The successive layers include support layers and object layers on the support layers. The additive manufacturing apparatus further includes a energy source to fuse the powder dispensed on the top surface of the platform, and a controller coupled to the dispensing system and the energy source. The controller is configured to cause the energy source to fuse a support region of each of the support layers to form a part support base in which a top surface of the part support base supports a bottommost layer of the object layers. The controller is further configured to cause the energy source to fuse an enclosure region of each of the object layers to form an enclosure dividing each of the object layers into an inner region and outer region. The controller is also configured to cause the energy source to fuse an object portion of the inner region of each of the object layers to form the object. A parallel projection of the object on the top surface of the platform defines a part area contained within the inner region.

In some examples, the inner region can include an area at least 120% to 150% of the part area.

In some examples, a lateral dimension of the inner region can be about 110% to 125% of a lateral dimension of the part area.

In some examples, a perimeter of the inner region can be a substantially constant distance from a perimeter of the part area.

In some examples, the enclosure can be formed along a perimeter of the part support base.

In some examples, the controller can be configured to cause the dispensing system to dispense the object layers over only the part support base.

In a further aspect, a method for forming an object includes dispensing successive layers of powder over a top surface a platform. The successive layers include support layers and object layers on the support layers. The method further includes fusing a support region of each of the support layers to form a part support base in which a top surface of the part support base supports a bottommost layer of the object layers. The method also includes fusing an enclosure region of each of the object layers to form an enclosure dividing each of the object layers into an inner region and outer region. The method further includes fusing an object portion of the inner region of each of the object layers to form the object. A projection of the object on the top surface of the platform defines a part area contained within the inner region.

In yet another aspect, an additive manufacturing apparatus for forming an object includes a platform and a dispensing system overlying the platform to dispense successive layers of powder over a top surface of the platform. The successive layers include post layers, part support layers on the post layers, and object layers on the support layers. The additive manufacturing apparatus further includes an energy source to fuse the powder dispensed on the top surface of the platform and a controller coupled to the dispensing system and the energy source and configured to cause the energy source to fuse a post region of each of the post layers to form posts. The controller is further configured to cause the energy source to fuse a support region of each of the part support layers to form a part support base in which a top surface of the part support base supports a bottommost layer of the object layers. The posts support a bottom surface of the part support base such that a gap separates the part support base from the platform. The controller is also configured to cause the energy source to fuse an object region of each of the object layers to form the object.

In some examples, the posts each can include a height between 1 and 100 mm.

In some examples, the posts can have a diameter of between 1 and 10 mm.

In some examples, the posts can be spaced at a pitch between 1 and 10 cm.

In some examples, a support post of the posts can include a vertical through-hole.

In some examples, the controller can be configured to cause the dispensing system to dispense the object layers over only the part support base.

In some examples, a parallel projection of the object on the top surface of the platform can define a part area. A parallel projection of the part support base on the top surface of the platform can define a support area. The support area can include the part area.

In another aspect, a method of forming an object includes dispensing successive layers of powder over a top surface of a platform. The successive layers include post layers, part support layers on the post layers, and object layers on the support layers. The method further includes fusing a post region of each of the post layers to form posts. The method also includes fusing a support region of each of the part support layers to form a part support base in which a top surface of the part support base supports a bottommost layer of the object layers. The posts support a bottom surface of the part support base such that a gap separates the part support base from the platform. The method also includes fusing an object region of each of the object layers to form the object.

Advantages of the foregoing may include, but are not limited to, the following. The additive manufacturing apparatuses and processes may more efficiently use powder dispensed during the operations to form the object or part. The powder that remain unfused after fusing operations may be reclaimed and reused for a subsequent dispensing operation so that less powder is wasted. This unfused powder may further be protected from unintended fusing and high temperatures. In some cases, when unfused powder is indirectly exposed to the higher temperatures required for fusing, this unfused powder may undergo caking. Reducing exposure of the powder to these higher temperatures may facilitate cleanup after the object has been completed. In addition, the reduced exposure can increase the amount of unfused powder that can be reclaimed and recycled.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1A is a schematic side view of an example of an additive manufacturing apparatus.

FIG. 1B is a schematic top view of the additive manufacturing apparatus of FIG. 1A.

FIG. 1C is an enlarged schematic side view of a top surface of a platform of an additive manufacturing apparatus.

FIG. 1D is an enlarged schematic top view of the top surface of the platform of FIG. 1C.

FIG. 2 is a block diagram of systems of an additive manufacturing apparatus.

FIG. 3A is a top perspective view of a build platform with a part support base.

FIG. 3B is a top perspective view of a build platform with support posts.

FIGS. 3C and 3D are cutaway top perspective views of the build platform as depicted in FIG. 3A.

FIGS. 4A to 4F are side cross-sectional views of an additive manufacturing apparatus performing operations to form an object.

Like reference numbers and designations in the various drawings indicate like elements.

### DETAILED DESCRIPTION

Additive manufacturing (AM) processes can form an object by dispensing and fusing successive layers of a powder on a build platform. For each layer, the AM processes can fuse only the portion of the powder corresponding to the object to be formed, leaving a portion of unfused powder on the platform. This unfused powder could be recycled and used for subsequent dispensing operations of the AM processes. The amount of powder suitable for reuse may be limited by inadvertent exposure to some of the operations of the AM processes. For example, some of the unfused powder may be exposed to higher temperature during the fusing process, causing caking of the powder around the object or the build platform. Dispensing and fusing these successive layers of powder can therefore require a large quantity of the powder substance and can lead to unwanted residue around the part and around the build platform.

To reduce the quantity of the powder used and to reduce the collateral effects of the fusing process on the unfused powder, AM processes can include reclamation and recovery operations to recover unfused powder. The recovery of the powder can enable the unfused powder to be used for a subsequent dispensing operation. The powder can be removed from the build area so that it is not exposed to the high temperatures that occur during the fusing process.

To facilitate the recovery operations, the AM processes can include operations to fabricate structures that can separate unfused powder from the portions of the powder that the AM processes will fuse to form the object. The structures can include walls and posts that enable the separation between the powder fused to form the object and the powder that are not fused to form the object. The walls can serve as retaining walls that retain the powder within a region of the build platform. These structures can reduce exposure of the unfused powder to the high temperatures. The structures can also enable the AM processes to recover unfused powder during the build process. In particular, the structures can include a support base that supports the powder in an object region corresponding to where the object will be formed. That support base can enable the powder within the object region to remain within the build area but allow powder outside of the object region to be recovered during the build process.

### Additive Manufacturing Apparatuses

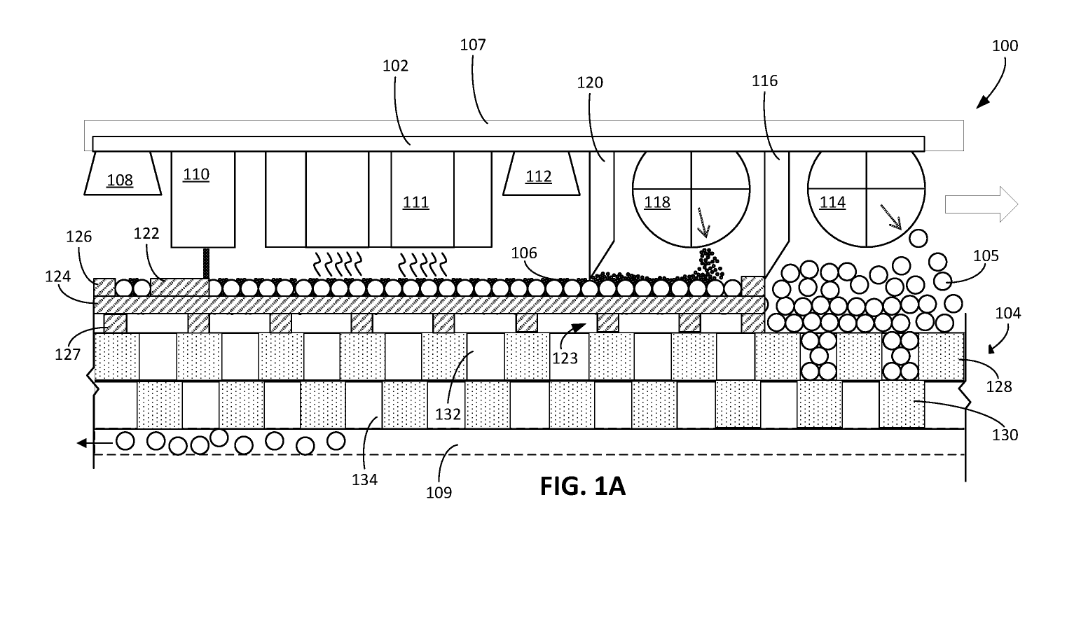

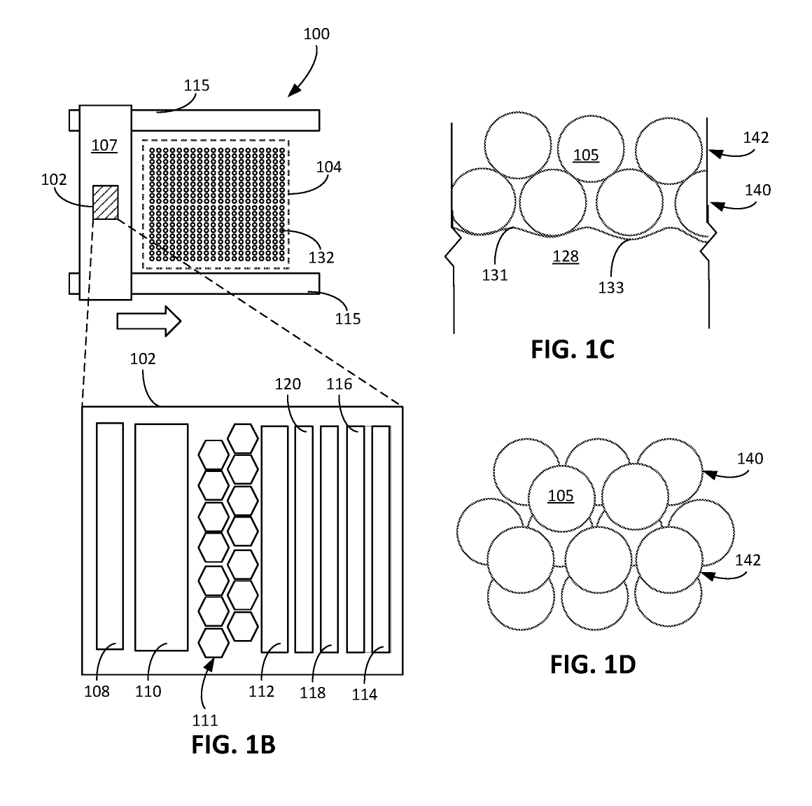

FIG. 1A shows a schematic side view of an example additive manufacturing (AM) apparatus 100 that can be used to recover unfused powder and reduce unwanted fusing of powder while forming an object during a build operation. The apparatus 100 includes a printhead 102 and a build platform 104. The printhead 102 dispenses a first powder 105 and fuses the powder 105 dispensed on the platform 104. Optionally, as described below, the printhead 102 can also dispense and fuse a second powder 106 on the platform 104. The printhead 102 can be modular and removable so that the printhead 102 can be easily replaced and maintained. Beneath the build platform 104 is a recycling channel 109 that can receive the powder to enable unfused powder to be reused during the build operation. With these systems, the apparatus 100 can dispense the powder and selectively fuse portions of the powder to form the object. The selective fusing can further allow the apparatus 100 to use a powder collection and recycling system to reclaim and recycle the powder.

The printhead 102 is supported on a gantry 107 that is configured to traverse the platform 104. For example, the gantry 107 can be driven along rails 115 by a linear actuator so as to move across the platform 104 in a first direction. In some implementations, the printhead 102 can move along the gantry 107 in a second direction perpendicular to the first direction, such that systems of the printhead 102 can reach different parts of the platform 104 beneath the gantry 107. The movement of the printhead 102 along the gantry 107 and the movement of the gantry 107 along the rails 115 provide multiple degrees of freedom for the printhead 102. The printhead 102 can be move along a plane above and parallel to the build platform 104 such that the printhead 102 can be selectively positioned above a usable area of the build platform 104 (e.g., an area where the powder can be dispensed and fused). The printhead 102 and the gantry 107 can cooperate to scan the usable area of the build platform 104 so that the printhead 102 can dispense and fuse powder as needed to form the object. Alternatively, the gantry 107 can include multiple printheads that span the width of the platform 104; in this case, motion of the printhead 102 along the second direction is not needed.

The printhead 102 includes several systems that enable the apparatus 100 to build objects. In particular, the printhead 102 can include a heat source 111, an energy source 110, and a first dispenser 114. The printhead 102 can additionally include a first spreader 116, a first sensing system 108, a second sensing system 112, a second dispenser 118, and a second spreader 120.

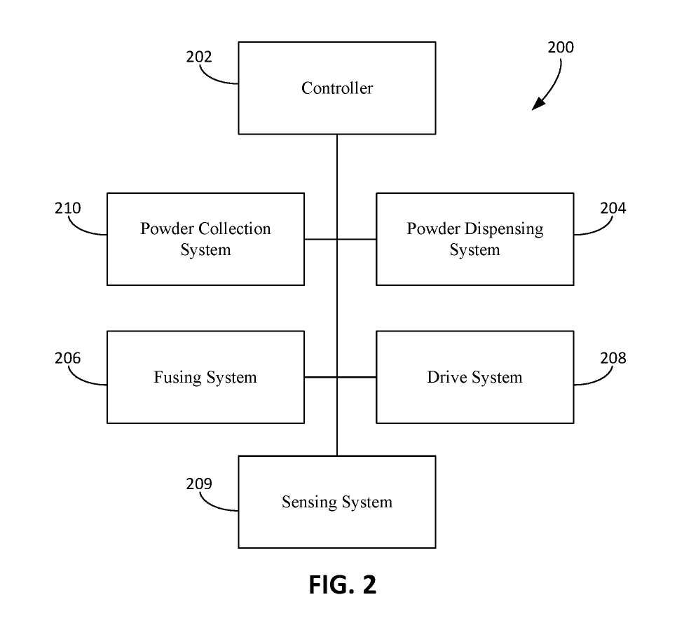

The operation of the energy source 110, heat source 111 and dispenser 114 can be coordinated by a controller 202 (see FIG. 2) to form different types of structures of the platform 104. The controller 202 can operate the energy source 110 and the heat source 111 to fuse the powder to form a workpiece 122 that becomes the object to be formed.

In addition, the controller 202 can cause the additive manufacturing apparatus 100 to form a structure that is not part of the intended object. This structure can be a sacrificial structure that is formed during each build operation of an object. Once the build operation is complete, the object is separated from the sacrificial structure, e.g., with a mechanical saw or laser. The sacrificial structure can then be melted down and the material recycled.

In some implementations, the energy source 110 is controlled by the controller 202 to fuse a portion of the layer of powder to form a support base 124 for the workpiece 122 and/or an enclosure 126 that encloses a region around the object. The support base 124 is a sacrificial temporary structure that can be formed during each build operation of an object. A top surface of the support base 124 defines a build area where the workpiece 122 and hence the object are formed. Because the support base 124 can span a large portion of the usable area of build platform 104, an area energy source can be used to form the support base 124 so that a larger portion of the layer of powder can be fused in a shorter amount of time.

The enclosure 126 is also a sacrificial temporary structure that can be formed during each build operation of an object. The enclosure 126 can extend upward from the support base 124. The enclosure 126 has a height that extends to an uppermost layer dispensed during the build operation. The enclosure 126, in cooperation with the support base 124, can retain some or all of the unfused powder 105 within the enclosure 126 and on top of the support base 124.

The controller 200 can cause the energy source 110 to fuse a portion of the layer of power to form support posts 127 that support the support base 124 on the platform 104. The support posts 127 can vertically separate the support base 124 from the platform 104 to form a gap 123 between the support base 124 and the platform 104. The platform 104 can serve as a heat sink that absorbs energy added to portions of the powder as it is being fused. By separating these portions from the platform 104, the gap 123 formed by the support posts 127 can increase efficiency of fusing operations that occur subsequent to the fusing of the support posts 127. The support posts 127 can reduce the amount of energy provided by the energy source 110 to the powder from being absorbed by the platform 104. The support posts 127 can further prevent residual heating of other powder contacting the platform 104 as the fusing operations occur.

A first dispensing system includes the first dispenser 114. The first dispensing system enables the printhead 102 to dispense the powder 105 and flatten the powder into a layer of relatively uniform thickness across the platform 104. The first dispensing system can dispense successive layers of powder onto the platform 104. Each successive layer can be supported by the underlying layer.

The thickness of each layer depends on, for example, the number of the powder particles 105 stacked through a height of the layer or the mean diameter of the powder particles 105. In some implementations, each layer of the powder particles 105 is a single particle thick. In some cases, each layer has a thickness resulting from stacking multiple powder particles 105 on top of each other. In some examples, each layer has a thickness of approximately one to four times the mean diameter of the powder particle 105.

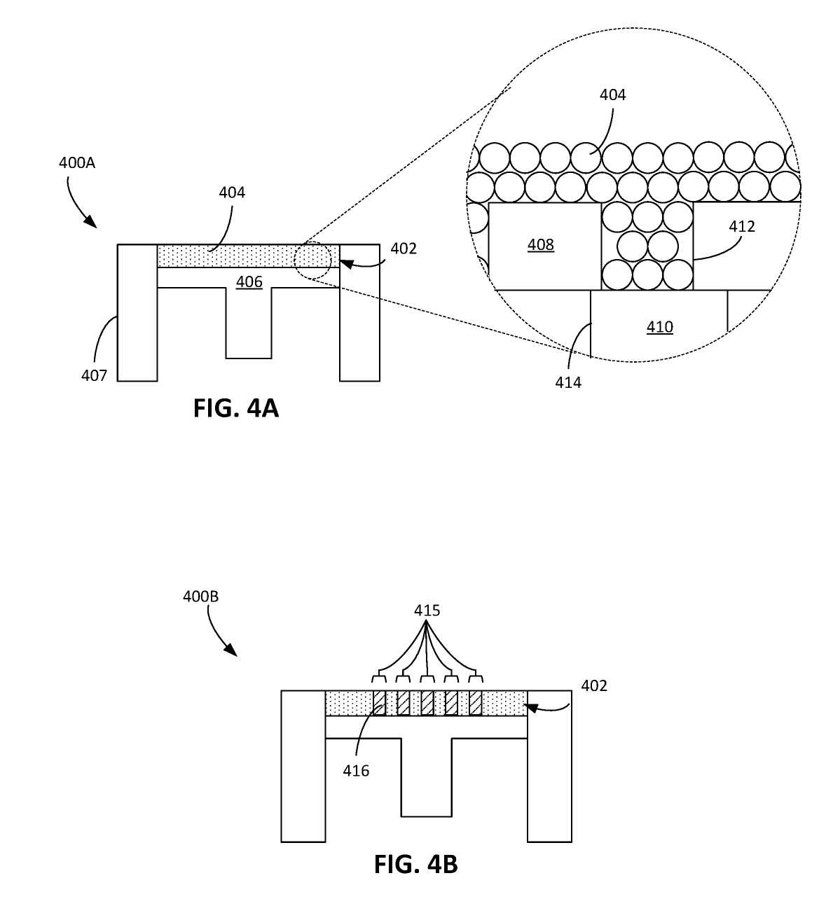

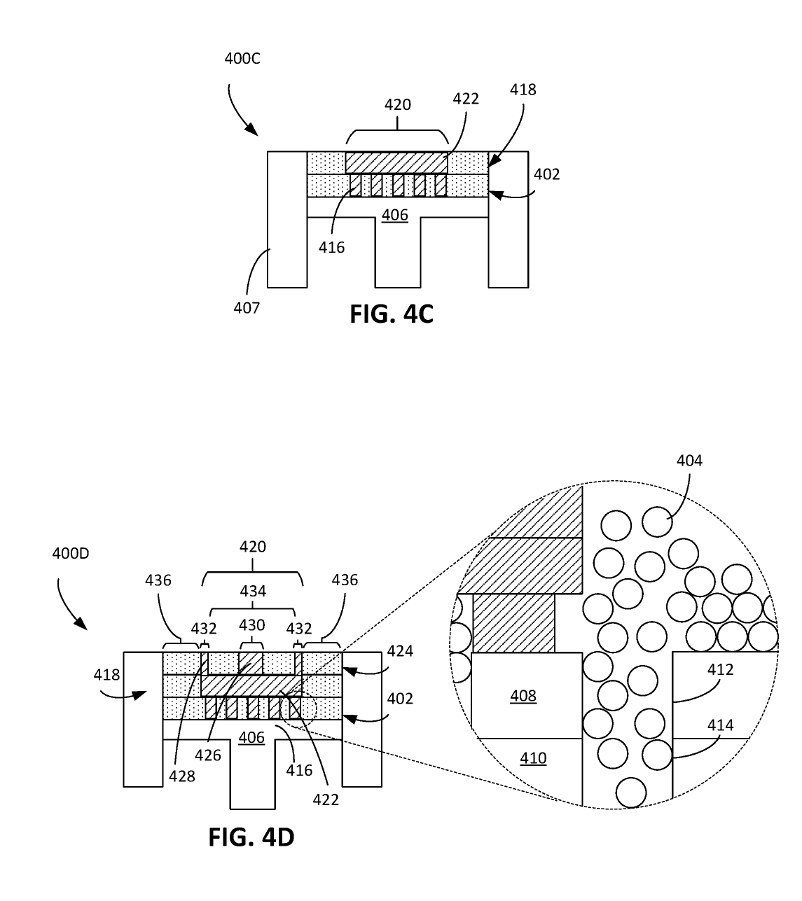

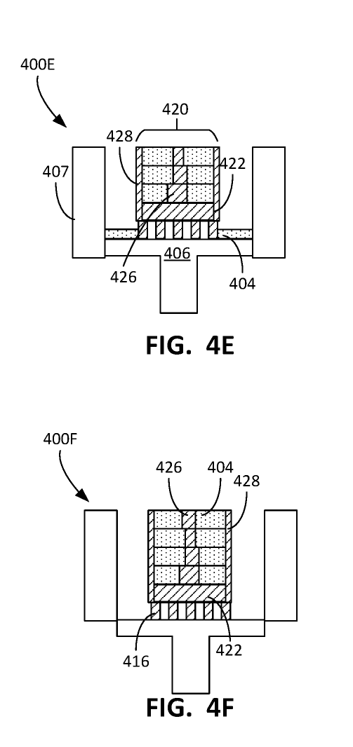

The thickness of each layer can further depend on the amount of support provided by the underlying layer or underlying structures. As will be described with respect to the process depicted in FIGS. 4A to 4F, for some layers dispensed, sidewalls of the apparatus 100 may not support the powder. For these layers, the thickness of the layer may be decreased to reduce shifting of powder that could occur in those layers due to gravity. As will also be described, the thickness can further depend on the type of the structures to be formed.

The distribution of powder dispensed for each layer can vary based on the implementation of the additive manufacturing apparatus. In some cases, the first dispenser 114 can selectively dispense a layer of powders on the work surface such that some portions include powder and some portions do not include powder.

In some implementations, the first dispenser 114 can include a rotating cylinder with perforations through which the powder is delivered. The controller 202 can operate a drive mechanism including a motor to drive the rotating cylinder. The drive mechanism can be part of the printhead 102 or can be independent from the printhead 102. Alternatively, the first dispenser 114 can include a piezoelectric ejector that ejects the powder in a carrier fluid.

The first spreader 116 can then further spread the powder across the build platform into a uniform layer with substantially uniform thickness. In some implementations, the first spreader 116 is a blade that translates across the platform 104. In some cases, the first spreader 116 is a roller that rolls across the platform 104. The controller 202 can translate the first spreader 116 by moving the printhead 102 or by independently moving the first spreader 116.

In some implementations, the apparatus 100, instead of or in addition to using the first dispenser 114, can use a dispenser independent from the printhead 102 to dispense the powder onto the platform 104. In some examples, the apparatus can include only the first spreader 116 without the first dispenser 114. In such cases, the apparatus 100 may include one or more powder delivery beds that holds the powder, and the printhead 102 with the first spreader 116 can push the powder from the delivery bed onto the build platform 104.

The apparatus 100 can include dispensing systems that are part of the printhead 102 and portions independent of the printhead 102. For example, the printhead 102 can include the spreader 116 while the apparatus 100 includes dispensers operable independently from these components, e.g., mounted separately on the gantry 107. The dispensers can dispense the powder onto the build platform 104, and the printhead 102 can move about the build platform 104 to spread the powder along the work surface.

Optionally, the printhead can include a second dispensing system to deliver a second powder. If present, the second dispensing system can include the second dispenser 118 and the second spreader 120. If the apparatus 100 includes two types of powders, the first powder particles 105 can have a larger mean diameter than the second particle particles, e.g., by a factor of two or more. When the second powder particles 106 are dispensed on a layer of the first powder particles 105, the second powder particles 106 infiltrate the layer of first powder particles 105 to fill voids between the first powder particles 105. The first powder particles 105 have, for example, a mean diameter that is at least 2 times larger than the mean diameter of the second powder particles 106. The second powder particles 106 can be submicron or nano-particles. In some examples, the mean diameter of the first powder particles 105 is between 2 and 100 times, 3 and 50 times, or 2 and 10 times larger than the mean diameter of the second powder particles 106. In some implementations, the first powder particles 105 have a mean diameter between 5 μm and 10 μm, and the second powder particles have a mean diameter between 100 nm and 2 μm.

In some implementations, the controller 202 can control the first and second dispensers 114, 118 to selectively deliver the first and the second powder particles 105, 106 to different regions. The first powder particles 105 can be dispensed above a selected region of the layer of the second powder particles 106 so that the second powder particles 105 can infiltrate into the layer of the first powder particles 106 within that selected region. The controller 202 can control the second dispenser 118 to dispense the second powder particles 106 for portions of the workpiece 122 that do not require the higher resolution and use a combination of the first and second powder particles for portions that require the higher resolution. For example, surface features of the final object may require higher resolution so that the object can perform its intended function. In some cases, the difference in sizes of the first and the second powder particles 105, 106 can be selected such that a compaction rate of the powder particles 105, 106 is within a desired range before the powder is sintered.

In implementations when multiples types of powders are used, the first and second dispensers 114, 118 can deliver the first and the second powder particles 105, 106 each into selected areas, depending on the resolution requirement of the structure to be formed. For example, to build the support base 124, the enclosure 126, the support posts 127, and other structures that do not form the workpiece 122, the dispensing system 204 can use the larger second powder particles 106. These structures may not require a high resolution, so the dispensing system 204 may decrease the amount of time required to form these structures by using the larger first powder particles 105. For the workpiece 122, the dispensing system 204 can use only the smaller second powder particles 106 to achieve a greater resolution for the final object to be formed. In some cases, the resolution requirement for the workpiece 122 may be low, and the dispensing system 204 can accordingly use the second powder particles 106 alone to form the workpiece 122 to reduce the amount of time required to fuse the powders 105, 106 into the workpiece 122. The dispensing system 204 can also use the second powder particles 106 alone so that the compaction rate is within the desired range.

Materials for the powder include metals, such as, for example, steel, aluminum, cobalt, chrome, and titanium, alloy mixtures, ceramics, composites, and green sand. In implementations with two different types of powders, in some cases, the first and second powder particles 105, 106 can be formed of different materials, while, in other cases, the first and second powder particles 105, 106 have the same material composition. In an example in which the apparatus 100 is operated to form a metal object and dispenses two types of powder, the first and second powder particles 105, 106 can have compositions that combine to form a metal alloy or intermetallic material.

The heat source 111 is operable to raise the temperature of the layer of powder to an elevated temperature that is still below the melting or sintering temperature of the powder. The energy sources 110 is then operable to fuse portions of the powder in the layer. The heat source 111 can deliver heat to a large region, e.g., the entire area beneath the printhead 102. For example, the heat source 111 can be an array of heat lamps that generate a uniform temperature increase across a layer of the powder deposited on the work surface.

In some implementations, the heat source 111 is a digitally addressable heat source in the form of an array of individually controllable light sources. The array includes, for example, vertical-cavity surface-emitting laser (VCSEL) chips, positioned above the platform 104. The array can be within the printhead 102 or be separate from the printhead 102. The array of controllable light sources can be a linear array driven by an actuator of the drive system 208 to scan across the platform 104. In some cases, the array is a full two-dimensional array that selectively heats regions of the layer by activating a subset of the individually controllable light sources. Alternatively or in addition, the heat source includes a lamp array to simultaneously heat the entire layer of the powder.

The energy source 110 can include one or more different types of energy sources that direct energy to localized regions of the powder on the platform 104 as small as a few millimeters in diameter (e.g., using a point energy source) or to larger regions (e.g., using an area energy source). A point energy source can be, for example, a laser that emits a laser beam onto a small portion of the powder.

In some implementations, the energy source 110 can include a scanning laser that generates a beam of focused energy that increases a temperature of a small area of the layer of the powder. The energy source 110 can fuse the powder by using, for example, a sintering process, a melting process, or other process to cause the powder to form a solid mass of material. In some cases, the energy source 110 can include an ion beam or an electron beam.

In some implementations, the energy source 110 can be independent of the printhead 102. In some examples, the apparatus 100 can include an energy source independent of the printhead 102 in addition to an energy source 110 incorporated into the printhead 102. The apparatus 100 can also include several energy sources that are each addressable such that the controller 202 can precisely control the areas of the build platform 104 receiving energy.

In some implementations, the controller 202 can control different energy sources and heat sources to produce different structures. For example, to form the support base 124, the controller 202 can control an area energy source such as a heater array so that the area of the support base 124 is fused in a shorter operation. To form the enclosure 126, because of the wall thickness of the enclosure 126 is smaller than the length and width of the support base 124, the controller 202 may use a point energy source such as a laser. The controller 202 can operate a combination of point and area energy sources to fuse each layer of the object, depending on the extent of the powder that needs to be fused to form that particular layer of the object.

The first sensing system 108 of the printhead 102 can detect properties of the surface of the workpiece 122 as well as properties of the powder. For example, the first sensing system 108 can detect deformations in the workpiece that may have been caused by, for example, the 3D printing process. The first sensing system 108 can also detect temperatures of the powder to ensure that fusing operations are properly raising the temperatures of the powder. In some implementations, the first sensing system 108 can detect dimensional characteristics of fused and unfused portions of the powder so that the control system 200 can monitor accuracy of the dimensions of the object as well as the other structures formed by the apparatus 100.

In some implementations, the first sensing system 108 detects the material of the powder, and the controller 202 subsequently selects a mode that modulates, for example, an amount of energy for the energy source 110 and/or the heat source 111 depending on the material detected. In some examples, the controller 202 can transmit instructions to the energy source 110 and/or the heat source 111 to decrease a power level and/or frequency so that the energy source 110 and/or the heat source 111 can add energy to a more precise portion that does not cause unfused powder to receive residual energy.

The first sensing system 108 includes, for example, an x-ray photoelectron spectrometer (XPS) that emits a beam of x-rays toward the workpiece 122 or the powder to detect material properties of the workpiece 122 or the powder. The XPS can detect a kinetic energy and a quantity of electrons escaping from the small portion and can determine material characteristics based on the kinetic energy and quantity. For example, the XPS can determine chemical composition and/or material defects and/or contaminants. In some cases, the XPS can be configured to determine chemical composition of a depth profile the workpiece 122. In some cases, the XPS can scan the surface of the workpiece 122 and determine element and chemical composition of a line profile of the surface of the workpiece 122. These sensors can further be used to scan the surfaces of the support base 124, the enclosure 126, and/or the support posts 127 to determine the properties of these structures. For example, the sensors may be able to detect if these structures have been properly fused.

The first sensing system 108 can, in some cases, detect roughness, surface finish, or other surface features using an interferometer, confocal microscope, or other appropriate surface detection system. The first sensing system 108 may also include an optical temperature sensor to determine a temperature of a portion of the workpiece 122. In some cases, the first sensing system 108 can include several temperature sensors that monitor temperatures at various points along the surface of the workpiece 122.

In some implementations, the apparatus 100 can include other sensors and detection equipment in addition to the first sensing system 108. For example, the apparatus 100 can optionally include the second sensing system 112. The second sensing system 112 can be positioned to detect a different portion of the powder or workpiece 122 than the first sensing system 112. In some cases, the first and second sensing systems 108, 112 are positioned to flank the energy source 110 and/or the heat source 111. As the printhead 102 moves along the platform 104, these sensing systems 108, 112 can accordingly sense properties of the powder before and after the energy source 110 and/or the heat source 111 add energy to the powder. In some implementations, the second sensing system 112 detects different properties than the first sensing system 108.

In some implementations, the apparatus 100 can further include sensors independent from the printhead 102. For example, a temperature sensor fixed to the build platform 104 can detect temperatures of the build platform 104. The apparatus 100 can also include a movable sensor that detects the temperature of powder outside of a build area for the workpiece 122. The build area can be defined by the support base 124. In some implementations, after the support base 124 is formed by the energy source 110 and/or the heat source 111, the printhead 102 can remain within the build area to perform the operations of dispensing and fusing successive layers of the powder. The apparatus 100 can include a movable sensor independent from the printhead 102 that detects the temperatures, material, or other properties of that powder outside of the build area.

In some implementations, the first sensing system 108 can detect that powder outside of the workpiece 122 are becoming fused during the fusing process. As described herein, exposure to the higher temperatures can cause caking and unintended fusing that can make the build platform 104 difficult to clean and can reduce the amount of powder available for reuse during a subsequent build operation.

The build platform 104 supports the powder and structures formed from the powder. FIG. 1C shows an enlarged side view of an example of a top surface 131 of the build platform 104. In some implementations, the top surface 131 can include a machined pattern that serves as a template to facilitate placement of the particles in the powder, e.g., into a hexagonal closest packed arrangement. The machined pattern may include recesses 133 that cause the bottommost particles of the powder 105 to be arranged in a two-dimensional hexagonal pattern.

As a result, as shown in FIG. 1D, which shows a top view of the powder 105 sitting on the top surface 131, the powder 105 achieve closer three-dimensional hexagonal packing. As shown in FIGS. 1C and 1D, a lower layer 140 of the powder 105, by occupying the recesses 133, can achieve the arrangement in the hexagonal pattern. The upper layer 142 of the powder 105 sits on top of the lower layer 140 also in a hexagonal pattern such that the lower and upper layers 140, 142 achieve close hexagonal packing. The close packing of the powder 105 may improve resolution of the structures formed after the powder 105 is fused.

Furthermore, if a second powder is used, having the particles of the first powder 105 in the hexagonal packing arrangement provides gaps that allow the smaller powder 106 to infiltrate through the layer of the larger powder 105. In some implementations, other than holes 132 discussed below, the top surface 131 is flat.

The build platform 104 can be moved upward or downward during build operations. For example, the build platform 104 can be moved downward with each layer dispensed by the first dispensing system 114 so that the printhead 102 can remain at the same vertical height with each successive layer dispensed. The controller 202 can operate a drive mechanism connected to the build platform 104 to decrease a height of the build platform 104 so that the build platform 104 can be moved away from the printhead 102. The build platform 104 can move vertically with a piston that controls the vertical height of the platform 104.

After each layer of the powder particles 105, 106 has been dispensed and fused, the piston can lower the platform 104. Any layers on the platform 104 lower with the platform 104 so that the platform 104 is ready to receive a new layer of powder. In some implementations, the piston lowers in increments of an expected thickness for each layer so that, each time the piston lowers the platform 104, the layers on the platform 104 are ready to receive the new layer.

After the build operation for an object is complete, the build platform 104 can be moved back up to an initial position in preparation for, for example, a cleanup or a build operation for a subsequent object.

Alternatively, the build platform 104 can be held in a fixed vertical position, and the gantry 107 can be raised after each layer is deposited.

The build platform 104, in addition to supporting dispensed powder and the structures formed during the additive manufacturing operations, can be operated to retrieve unused powder from a top surface of the build platform 104. The build platform 104 includes a first support plate 128 and a second support plate 130.

Referring back to FIG. 1A, the first support plate 128 includes an array of holes 132 that extend from a top surface of the first support plate 128 to a bottom surface of the first support plate 128. The second support plate 130 can be immediately beneath the first support plate 128 and includes an array of holes 134 that extend from a top surface of the second support plate 130 to bottom surface of the second support plate 130. The recycling channel 109 can be connected to the holes 134. The top surface of the second support plate 130 can contact a bottom surface of the first support plate 128.

The holes 132 of the first support plate 128 may have a different size than the holes 134 of the second support plate 130. The holes 132 may be narrower or wider than the holes 134. The holes 132, 134 may each have a width between 1 and 100 mm. The narrower of the holes 132, 134 may each have a width between 1 and 100 mm, and the wider of the holes 132, 134 may each have a width between 1 and 100 mm. The holes 132, 134 may be circular, hexagonal, square, or other appropriate horizontal cross-sectional shape. The holes 132 may be uniformly spaced across the first support plate 128, e.g., in a rectangular or hexagonal pattern, and with a pitch between 1 and 100 mm.

The first and second support plates 128, 130 are movable relative to one another. These plates 128, 130 can move in a plane parallel to one another between an aligned configuration and a misaligned configuration. For example, the second support plate 130 can be movable relative to the first support plate 128 in a plane parallel to the top surface of the first support plate 128 and/or the top surface of the second support plate 130. The controller 202 can operate a drive mechanism to move the support plates 128, 130 relative to one another. In particular, the controller 202 can move the support plates 128, 130 between the aligned configuration and the misaligned configuration. The drive mechanism can include a motor and/or a linear actuator connected to the first support plate 128 and/or second support plate 130 to move the support plates 128, 130 relative to one another. In some cases, only one of the first and second support plates 128, 130 move while the other plate remains stationary.

In the misaligned configuration, the holes 132, 134 of each plate 128, 130 are not aligned with one another. In this configuration, the second support plate 130 creates a barrier for unfused powder. Thus, unfused powder is held on the top surface of the first support plate 128 and can fill the holes 134, but the second support plate 130 prevents the powder from flowing into the recycling channel 109. In FIG. 1A, the plates 128, 130 are depicted to be in the misaligned configuration.

In the aligned configuration, the holes 132, 134 of each plate 128, 130 are aligned with one another such that the holes 132, 134 form a channel that extends from the top surface of the first support plate 128 to the recycling channel 109, which is connected to the holes 134. As a result, unfused powder on the top surface of the first and second support plates 128, 130 can flow through the holes 132, 134 (e.g., with gravity or with air caused by suction applied at inlets to the recycling channel 109). The unfused powder can enter the recycling channel 109 and can be used for a subsequent dispensing operation for the first and second dispensing systems.

The apparatus 100 can further include a reclaiming module to control reclamation and recycling of the powder received in the recycling channel 109. The reclaiming module can include a flow network of channels, valves, and flow controllers that can divert the powder received in the recycling channel 109 to their appropriate destinations. The reclaiming module can be operable with the flow network so that the reclaiming module can detect properties of the powder as the powder travels within the flow network. The controller 202 can control addressable valves that can divert the powder toward different channels or conduits. In some implementations, the reclaiming module can include vacuum sources, gas sources, and/or air movers that propel the powders 105, 106 toward the different destinations.

During a build, the reclaiming module can be configured such that powder delivered to the powder hopper of the dispensing system dispenses powder having quality and properties similar to the powder previously dispensed by the dispensing system. The reclaiming module is configured to detect a particle size of the unfused portion of the powder such that the first dispenser 114 dispenses only particles of the unfused portion of the powder having a particle size less than a predetermined threshold size. The predetermined threshold size can be a width based on the size of the particles to be sorted. The reclaiming modules can thus sort the powder by particle size. In some cases, the sorting by particle size can also function to remove powder particles that have increased in size due to fusing. These fused particles may be sorted out by the particle size detector. In some cases, the powder may experience fusing but are still sufficiently small to be used for a subsequent build operation. In some implementations, in addition to or instead of sensors to detect the size of the powder, the reclaiming module can include a series of filters that separate the powder by size.

In some implementations, the reclaiming module can perform quality control operations of reclaimed powder. The reclaiming modules can include sensors to detect morphology and particle size of the powder for selective screening of the particles within specifications. After the powder is reclaimed in the recycling channel 109 by moving the support plates 128, 130 to the aligned configuration, the reclaiming module can redirect reusable powder toward the first dispenser 114 such that the powder can be used during the present build operation. The powder reclaiming module, in some cases, may direct the powder toward a reservoir for a subsequent build operation. The reclaiming module can direct unusable powder toward a disposal system, where the powder is taken for disposal, remediation, and/or recycling.

In implementations in which the apparatus 100 dispenses multiple types of powders, the reclaiming module can sort the particle sizes of the first and second powders 105, 106 received in the recycling channel 109. The reclaiming modules can include a series of filters to perform the sorting or can include sensors to detect the particle size. The controller 202 can control valves to then direct the different sized particles to the appropriate dispensers. The controller 20 can operate the valves of the reclaiming module to guide the first powder particles 105 to the first dispenser 114 and the second powder particles 106 to the second dispenser 118.

### Control System

To perform operations described herein, referring to FIG. 2, the apparatus 100 includes a control system 200. The controller 202 controls the operations of the sub-systems of the control system 200, including a powder dispensing system 204, a fusing system 206, a drive system 208, a sensing system 209, and a powder collection system 210. The powder dispensing system 204 and the fusing system 206 can be part of the printhead 102. The controller 202 can include a computer aided design (CAD) system that receives and/or generates CAD data. The CAD data is indicative of the object to be formed, and, as described herein, can be used to determine properties of the structures formed during additive manufacturing processes. Based on the CAD data, the controller 202 can generate instructions usable by each of the systems operable with the controller 202, for example, to dispense the powders 105, 106, to fuse the powders 105, 106, to move various systems of the apparatus 100, and to sense properties of the systems, powders 105, 106, and the workpiece 122.

Referring to FIGS. 1A, 1B, and 2, the powder dispensing system 204 includes, for example, the first and second rollers 114, 118, and the first and second blades 116, 120 to dispense the first and second powders 105, 106 on the build platform 104. The controller 202 can transmit instructions to the powder dispensing system 204 to dispense powders 105, 106 onto the build platform 104.

The fusing system 206 can fuse powders 105, 106 dispensed on the work surface using one or more energy sources. The powders 105, 106 can be fused to form the workpiece 122, the support base 124, the enclosure 126, and/or the support posts 127. The controller 202 can execute successive depositing and fusing of the powder to generate the part corresponding to CAD data from the controller 202.

A drive system 208 of the control system 200 can include drive mechanisms that move various components of the apparatus. In some implementations, the drive system 208 can cause translation and/or rotation of these different systems, including dispensers, rollers, support plates, energy sources, heat sources, sensing systems, sensors, dispenser assemblies, dispensers, and other components of the apparatus 100. Each of the drive mechanisms can include one or more actuators, linkages, and other mechanical or electromechanical parts to enable movement of the components of the apparatus.

The drive system 208, in some cases, controls movement of the printhead 102 and can also control movements of individual systems of the printhead 102. For example, the drive system can cause the printhead 102 to move to a particular location along the gantry 107, and the drive system can further actuate a separate drive mechanism to move the roller of the printhead 102 along the printhead 102. The drive system can also move the gantry 107 along the build platform 104 so that the printhead 102 can be positioned above different areas of the build platform 104. The drive system can include drive mechanisms to rotate the rollers 114, 118. The drive system 208 can, in some cases, also independently control the position of the energy sources 110, 111 relative to the printhead 102.

The sensing system 209 includes, for example, the sensing systems 108, 112 of the printhead 102. The sensing system 209 can include sensors part of the reclaiming module, the build platform 104, the first dispenser 114, and other systems of the apparatus 100. The sensing system 209 detects properties of the powder, the structures formed by the apparatus 100, and the individual systems of the apparatus 100. The sensing system 209 can also monitor operational parameters of the apparatus 100, such as available powder and energy usage. The sensing system 209 can also monitor an amount of powder that is being recycled.

The powder collection system 210 can cooperate with the sensing system 209 to recycle powder. The powder collection system 210, which can include the reclaiming module, serves to retrieve unfused powder from the build platform 104 so that this powder can be reused. The powder collection system 210, in conjunction with the sensing system 209 can determine which of the powder retrieved from the build platform 104 are usable for a subsequent operation. The controller 202 can control the powder collection system 210 to divert the powder to the appropriate dispenser of the dispensing system 204. While the powder collection system 210 and the dispensing system 204 have been described as separate systems, these systems 204, 210 may cooperatively operate as a single system.

In some implementations, the powder may have been exposed to a sufficiently high temperature that small amounts of fusing have occurred. In those cases, the sensing system 209 can determine that portions of the powder received by the reclaiming module are not recyclable. The powder collection system 210 can further cooperate with the drive system 208 so that the powder collection system 210 can control when the support plates 128, 130 are moved relative to one another to initiate reclamation of the powder using the reclaiming module. As described above, when the support plates 128, 130 are moved to the aligned configuration, the unfused powder on the top surface of the first and second support plates 128, 130 can be reclaimed. The powder collection system 210 can then initiate the sensing operations to detect whether the reclaimed powder is usable.

### Build Platform and Support Structures

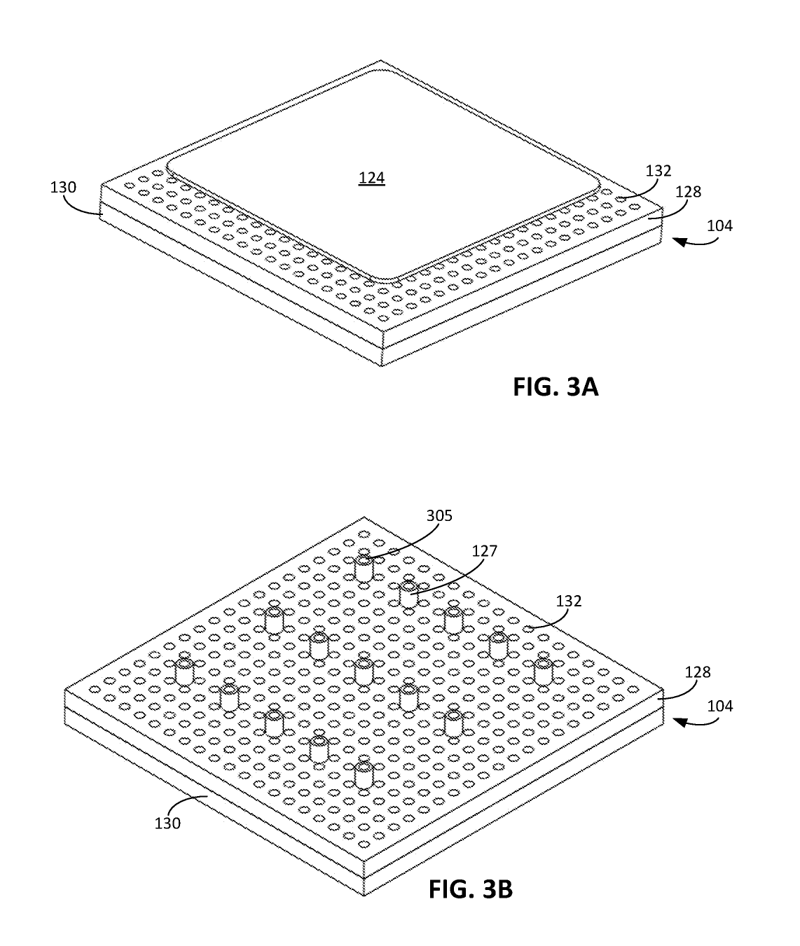

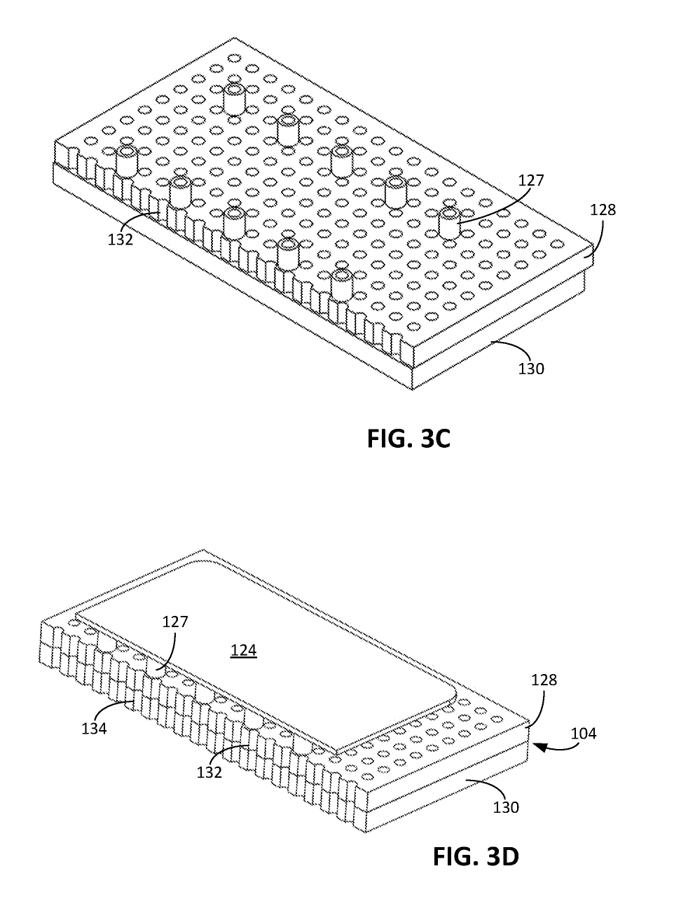

As described above, to initiate a recycling process, the powder collection system 210 and the drive system 208 can move the support plates 128, 130 of the build platform 104 from the misaligned configuration to the aligned configuration. Referring to FIGS. 3A to 3D, the holes 132 in the first support plate 128 cooperate with the holes 134 in the second support plate 130 to enable the reclamation of the powder. The non-workpiece structures formed by the dispensing system 204 and the fusing system 206 further improve the efficiency of the powder recycling process and reduce the unintentional fusing of powder that does not become the object to be formed. These structures, as described above, include the support base 124, the enclosure 126 (shown in FIG. 1A), and the support posts 127. The enclosure 126 is built as the workpiece 122 (shown in FIG. 1A) is built. The support base 124 and the support posts 127 are structures formed before the workpiece 122 is begun to be built.

As shown in FIG. 3A, the support base 124 is substantially parallel to the top surface of the build platform 104. The support base 124 has a size smaller than the top surface of the build platform 104. The support base 124 defines a support region that corresponds to an area of the object to be formed and an area of the enclosure to be formed. The support region is sufficiently large to support both the object as well as the enclosure. In particular, a parallel projection of the object and the enclosure on the top surface of the support base 124 is contained within the support region.

Before the support base 124 is formed, the controller 202 can cause the dispensing system 204 and the fusing system 206 to form the support posts 127. FIG. 3B shows the support posts 127 on the top surface of the build platform 104. The support posts 127 are spaced apart so that they can structurally support the 124 and the predicted combined weight of the enclosure, the object to be formed, and unfused powder contained within the enclosure and the support base 124. The controller 202 can compute the weight of these components and accordingly generate instructions that define a number, a diameter, a thickness, a distribution, a height, and other properties of the support posts 127 to be formed. The support posts 127 can an array across the build platform 104 that are staggered with the position of the holes 132 of the first support plate 128 so that the support posts 127 do not block the holes 132. The support posts 127 can further include vertical through-holes 305, which can reduce the amount of powder required to form the support posts 127.

FIGS. 3A and 3B depict the support plates 128, 130 in the aligned configuration. As described above with respect to FIG. 1A, in this configuration, the powder can travel through the holes 132, 134 of the support plates 128, 130 to be reclaimed through the recycling channel 109. In the misaligned configuration, powder dispensed on the top surfaces of the first and second support plates 128, 130 remain on the top surfaces.

FIGS. 3C and 3D show a cross-sectional view of the build platform 104 in the misaligned configuration (FIG. 3C) and the aligned configuration (FIG. 3D), respectively. In the misaligned configuration (FIG. 3C), the holes 132, 134 are not aligned with one another. As a result, the holes 132 are blocked by the second support plate 130 so that the powder cannot travel through the support plates 128, 130 to the recycling channel 109 (shown in FIG. 1A). In the aligned configuration (FIG. 3D), the holes 132, 134 are aligned with one another such that the powder can travel through a channel formed by the aligned holes 132, 134. The support base 124 can support the powder dispensed on the support base 124 so that the powder remains on the support base 124 and does not travel through the channel formed by the aligned holes 132, 134. After the powder travels through the channel formed by the aligned holes 132, 134 and is received in the recycling channel, the powder can then be sorted and re-directed through the reclaiming module and the powder collection system 210.

### Methods of Using Additive Manufacturing Apparatuses

The apparatus 100 and other AM apparatuses described herein can be used to fabricate support structures for an object and to recycle unfused powder for subsequent use. FIGS. 4A to 4F show a process implemented by an AM apparatus (e.g., the AM apparatus 100 of FIG. 1A) to form an object. FIGS. 4A to 4F depict sequential operations 400A to 400F in which the apparatus performs operations including dispensing the powder, fusing the powder, and reclaiming powder that was not fused. Before beginning the operations 400A to 400F, the controller (e.g., the controller 202) of the apparatus can receive CAD data indicative of the object to be formed. As is described herein, using the CAD data, the controller can select properties of various structures formed during the operations 400A to 400F.

At operation 400A, as depicted in FIG. 4A, the apparatus dispenses one or more layers 402 of powder particles 404 on a build platform 406. The apparatus can be, for example, the apparatus 100 described with respect to FIG. 1A. The build platform 406 can be the build platform 104 of the apparatus 100. Each layer 402 can include several powder particles 404 stacked on top of one another. When the apparatus dispenses the layers 402, the layers 402 can have a height that extends to a top surface of side walls 407 of the apparatus.

FIG. 4A further shows an enlarged portion near a top surface of the build platform 406. As shown in that enlarged portion, the build platform 406 includes a first support plate 408 on top of a second support plate 410. The first support plate 408 includes an array of holes 412, and the second support plate 410 includes an array of holes 414. The first support plate 408 and the second support plate 410 can be the first support plate 128 and the second support plate 130, respectively, described with respect to FIG. 1A.

When the first layers 402 of powder 404 are dispensed, the first and second support plates 408, 410 are in the misaligned configuration. Thus, during the operation 400A, when the layers 402 of powder 404 are dispensed on the top surface of the build platform 406, the powder 404 may enter the holes 412 of the first support plate 408, but the second support plate 410 prevents the powder 404 from moving farther than the second support plate 410. While the layers 402 have been described as multiple layers of the powder particles 404, in some cases, the layers 402 includes only a single layer of the powder particles 404.

At operation 400B shown in FIG. 4B, the apparatus fuses a portion of the layers 402 to form support posts 416. The apparatus fuses through all of the layers 402 to the build platform 406 so that the fused portions are firmly supported on the build platform 406. The apparatus fuses a post region 415 corresponding to a horizontal cross-section of each of the support posts 416. For circular posts, the post region 415 may be a discontinuous set of annular regions, e.g., circular rings, each annular region corresponding to one of the support posts 416. In some implementations, when the posts 416 include through-holes, each of the support posts 416 formed in the post region 415 may include an inner circumference and an outer circumference. In some implementations, the posts 416 may have a square, rectangular, hexagonal, or other appropriate cross-sectional shape. The posts 416 are shown to be solid in FIGS. 4B to 4F, though in some examples, the support posts are hollow.

At operation 400C shown in FIGS. 4C, the apparatus dispenses one or more layers 418 on top of the layers 402. As described with respect to the layers 402, each layer 418 can include several powder particles 404 stacked on top of one another. As part of this operation 400C, the apparatus can lower the build platform 406 such that the new layers 418 dispensed on the layers 402 reaches the top surface of the side walls 407 or raise the gantry 107 to maintain the same height of the printhead 102 over the top layer of powder on the platform.

During the operation 400C, the apparatus also fuses a portion of the layers 418. In particular, the apparatus fuses a support region 420 of the layer 418. The area covered by support region 420 corresponds to an area of a top surface of the part support base 422. The part support base 422, during the fusing operation, can become fused to the support posts 416. As a result, at the end of the operation 400C, the support posts 416, in the absence the unfused powder underlying the part support base 422, support the part support base 422 above the build platform 406.

At operation 400D shown in FIG. 4D, the apparatus dispenses more layers 424 of the powder 404 on top of the layers 418. Similar to the layers 402, 418, the layers 424 can include several powder particles 404 stacked on top of one another. The apparatus also lowers the build platform 406 such that the new layers 424 reach but do not exceed the top surface of the side walls 407, or raises the gantry 107 to maintain the same height of the printhead 100 over the top layer of powder on the platform.

The bottommost layer of the layers 424 rests on the part support base 422. The part support base 422 supports a portion of the layers 424 that overlie the part support base 422. The portion of the layers 424 supported by the part support base 422 are within the support region 420.

During the operation 400D, the apparatus also fuses portions of the layers 424 to begin forming a workpiece 426 and an enclosure 428. The workpiece 426 is part of the object to be formed. To form the workpiece 426, the apparatus fuses an object portion 430 of the layers 424. The enclosure 428 is formed along a perimeter of the part support base 422. To form the enclosure 428, the apparatus fuses an enclosure region 432 of the layers 424.

Unlike the layers 402, 418 dispensed and fused in operations 400A to 400C, the portions of the layers 424 that are fused during operation 400D can become part of the object being built. The layers 424 and subsequent layers can thus be considered object layers that include powder 404 that are fused to form the object. In particular, as described above with respect to FIGS. 4A to 4C, the initial layers 402, 418 are fused to form support structures for the workpiece 426. These support structures, including the part support base 422 and the support posts 416, do not become the object being built but rather support the object as it is being built.

The enclosure 428, similar to the part support base 422 and the support posts 416, does not form part of the object being built. The enclosure 428 divides the layers 424 into an inner region 434 and an outer region 436. The inner region 434 sits within the part support base 422 and thus the support region 420. The support region 420 can correspond to the region including both the enclosure region 432 and the support region 420. The inner region 434 contains the powder 404 that will be fused to form the object. The outer region 436 contains the powder 404 that will not receive energy from the energy sources during the additive manufacturing process. The height of the enclosure 428 extends to the uppermost layer 424.

Before executing the operations 400A to 400D, the controller of the apparatus can set dimensions of the support posts 416, the part support base 422, and the enclosure 428 based on dimensions of the object as determined from CAD data representing the object as received prior to initiating the operation 400A. In some implementations, the controller can compute a parallel projection of the object on the top surface of the platform 406. The parallel projection can correspond to an area of the object as it would appear projected along a direction perpendicular to the top surface of the platform 406 onto the top surface of the platform 406. The parallel projection of the object on the platform can therefore define a part area. Based on the parallel projection, the controller can select geometric properties of the post region 415, the support region 420, and the enclosure region 432. The controller can select an area of the support region 420 and accordingly select the location of the enclosure region 432 based on the area of the support region 420.

The controller can select the area of the support region 420 such that the support region 420 includes the area of the object. The controller can further select the area of the support region 420 such that the inner region 434 defined by the enclosure 428 includes the area of the object. In some examples, the inner region 434 has an area at least 105% to 200% (e.g., 105% to 150%, 120% to 150%, 150% to 200%) of the area of the object. As the inner region 434 can be equal to the support region 420 minus the area occupied by the enclosure 428, the inner region 434 is less than or equal to the support region 420.

In some examples, the controller sets lateral dimensions of the inner region 434 such that the greatest lateral dimensions of the object are included in the lateral dimensions of the inner region 434. The controller sets, for example, the width and/or length of the inner region 434. A lateral dimension of the inner region 434 can be, for example, 105% to 150% (e.g., 105% to 110%, 110% to 125%, 125% to 150%) of a lateral dimension of the object area.

In some implementations, the controller determines a perimeter of the area of the parallel projection of the object on the platform 406. Based on the perimeter of that parallel projection, the controller sets a geometric shape and area of the inner region 434 that follows the perimeter of the parallel projection. For example, the perimeter of the inner region can be generated simply by scaling the perimeter of the perimeter of the parallel projection.

The inner region 434 can occupy a shape and location that causes its perimeter to be substantially a constant distance from a perimeter of the area of the parallel projection of the object. For example, the perimeter of inner region 434 can be a distance from the perimeter of the parallel projection such that the area of inner region 434 is in the ranges as described above. In some examples, the perimeter of the inner region 434 is within a set distance from the perimeter of the area of the parallel projection, for example, between 1 mm 10 cm, from the perimeter of the area of the parallel projection.

In some examples, the part area defined by the parallel projection of the object can be included in a parallel projection of the part support base 422 onto the platform 406. The parallel projection of the part support base 422 can define a support area. The support area therefore can include the part area.

In some implementations, the controller can determine dimensions of the support posts 416 before the operation 400A. The controller can, for example, determine a weight of the object to be formed before the operation 400A. Based on the weight of the object, the controller can select the post region 415 as well as a height of the layers 402 dispensed at the operation 400A. The support posts 416 separate the part support base 422 from the top surface of the platform 406 and thus also separate the workpiece 426 and the enclosure 428 from the part support base 422. As described above, the separation can insulate the platform 406 from the part support base 422, the workpiece 426, the enclosure 428, and the powder 404 contained within the enclosure 428 and the part support base 422. The separation and insulation can reduce heat provided to the powder 404 within the enclosure 428 from being transferred to the platform 406. The controller can select the height of the layers 402, and hence the support posts 416, to create sufficient separation between the part support base 422 and the top surface of the platform 406. The controller can further select cross-sectional characteristics of the support posts 416 such that the support posts 416 have enough strength to withstand the load of the object, the part support base 422, unfused powder 404 within the inner region 434, and the enclosure 428.

In some cases, alternatively or additionally, the controller can select cross-sectional characteristics of the support posts 416 based on a predicted volume of the portion of the layers dispensed in the support region 420 after the object is complete. Based on this volume and an average density of the powder 404 used during the build operation, the controller can compute a weight that the support posts 416 will support after the completion of the object. The controller can then according select dimensions and geometric characteristics of the posts 416 to support this weight. In some implementations, if there is a non-uniform distribution of the load on the support posts 416, each of the support posts 416 may have a different size or dimension based on the amount of load that it supports.

In some examples, the support posts 416 have a height between 1 and 100 mm. The support posts 127 can have a diameter of between 1 and 10 mm. The support posts 416 can be spaced at a pitch between 1 and 10 cm. A cross-sectional area of the support posts 416 can be defined relative to a cross-sectional area of the support region 420.

After the formation of a portion of the enclosure 428 and the workpiece 426 at operation 400D, the apparatus can activate one or more actuators connected to the platform 406 to move the first support plate 408 and the second support plate 410 relative to one another. As shown in the enlarged portion of FIG. 4D, the plates 408, 410 are moved relative to one another to enable the powder 404 to travel through the holes 412, 414. In particular, the plates 408, 410 are moved from the misaligned configuration to the aligned configuration. In some implementations, the actuators cause the first support plate 408 to move relative to the second support plate 410, and in some cases, the actuators cause the second support plate 410 to move relative to the first support plate 408.

When the plates 408, 410 are moved to the aligned configuration, as shown in the enlarged portion of FIG. 4D, the powder 404 within the inner region 434 remain in the inner region 434, but the powder 404 in the outer region 436 flows out through the holes 412, 414. The location of the enclosure 428 along the part support base 422 thus defines which of the powder 404 is collected through the holes 412, 414 and which of the powder 404 remains above the build platform 406. The powder 404 that remained above the build platform 406 is contained within the enclosure 428 and above the part support base 422. The powder 404 in the inner region 434 remains supported by the part support base 422, in turn supported by the support posts 416, in turn supported by the platform 406. The powder 404 in the inner region 434 are laterally supported by the enclosure 428

The powder 404, after travelling through the holes 412, 414, enter the recycling channel of the apparatus. As described above with respect to FIG. 2, the powder collection system of the apparatus can determine destinations of the reclaimed powder 404 depending on the properties of the powder 404 sensed using sensors associated with the powder collection system. After the powder 404 enters the recycling channel, the apparatus, for subsequent operations, can begin using reclaimed powder that the powder collection system has determined to be usable for subsequent operations.

At operation 400E shown in FIG. 4E, the apparatus continues dispensing the powder 404 on the build platform 406 and fusing powders 404 within the inner region 434 to form the enclosure 428 and the workpiece 426. The powder 404 dispensed during the operation 400E may include powders previously dispensed in operations 400A to 400D and reclaimed and recycled during the operation 400D. The apparatus can uniformly dispense the powder 404 on the platform 406. The plates 408, 410 can remain in the aligned configuration such that the powder 404 dispensed in the outer region 436 falls through the holes 412, 414 upon being dispensed onto the build platform 406. As the powder 404 is dispensed in the support region 420, the powder 404 can accumulate to form a new layer.

In some cases, the apparatus does not dispense the powder 404 over all of the outer region 436. Instead, the apparatus only dispenses the powder 404 only within the support region 420, or over an area including the support region 420 and an area immediately adjacent the support region 420, e.g., as limited by the resolution of the dispensing system. The decreased amount of powder 404 dispensed may decrease the amount of time to dispense the object layers.

The powder 404 dispensed in the support region 420 remain on top of the uppermost layer previously dispensed. The apparatus can then fuse the powder 404 in the enclosure region 432 to extend the height of the enclosure 428. The apparatus can also fuse a portion of the powder 404 to continue adding fused material to the workpiece 426 and continue formation of the object. The apparatus can continue dispensing and fusing the powder 404 until the object is complete.

In some examples, the layers dispensed after the plates 408, 410 are moved to the aligned configuration (e.g., after the operation 400D) can have a smaller height than the layers 402, 418, 424. The layers dispensed when the plates 408, 410 are in the aligned configuration are not laterally supported by the side wall 407 and other powders 404. The powder 404 dispensed in the enclosure region 432 could therefore shift toward the outer region 436. These layers may have a smaller thickness so that the powders 404 in these layers 424 do not significantly shift after they are dispensed.

At operation 400F, the apparatus has completed fusing material to the workpiece 426 and hence has completed formation of the object. The workpiece 426 with the part support base 422, the support posts 416, and unfused powder 404 within the inner region 434, can be removed from the apparatus. The support posts 416 can be broken off or cut off from the part support base 422. The part support base 422 can be removed from the workpiece 426. For example, the support posts 416 and the part support base 422 can be removed through an electrical discharge machining (EDM) operation. The unfused powder 404 within the inner region 434 can be disposed of or placed into the powder collection system for the powder collection system to determine which of the powder 404 is reusable and which of the powder 404 will be disposed of. Controllers and computing devices can implement the operations 400A to 400F and other processes and operations described herein. As described above, the controller 202 of the apparatus 100 can include one or more processing devices connected to the various components of the apparatus 100, e.g., actuators, valves, and voltage sources, to generate control signals for those components. The controller can coordinate the operation and cause the apparatus 100 to carry out the various functional operations or sequence of steps described above. The controller can control the movement and operations of the systems of the printhead 102. The controller 202, for example, controls the location of feed material, including the first and second powder particles. The controller 202 also controls the intensity of the energy source based on the number of layers in a group of layers to be fused at once. The controller 202 also controls the location where energy is added by, for example, moving the energy source or the printhead.

The controller 202 and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

The controller 202 and other computing devices part of systems described can include non-transitory computer readable medium to store a data object, e.g., a computer aided design (CAD)-compatible file that identifies the pattern in which the feed material should be deposited for each layer. For example, the data object could be a STL-formatted file, a 3D Manufacturing Format (3MF) file, or an Additive Manufacturing File Format (AMF) file. For example, the controller could receive the data object from a remote computer. A processor in the controller 202, e.g., as controlled by firmware or software, can interpret the data object received from the computer to generate the set of signals necessary to control the components of the apparatus 100 to fuse the specified pattern for each layer.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The printhead of FIG. 1A includes several systems that enable the apparatus 100 to build objects. In some cases, instead of a printhead, an AM apparatus includes independently operated systems, including independently operated energy sources, dispensers, and sensors. Each of these systems can be independently moved and may or may not be part of a modular printhead. In some examples, the printhead includes only the dispensers, and the apparatus include separate energy sources to perform the fusing operations. The printhead in these examples would therefore cooperate with the controller to perform the dispensing operations.

While the operations 400A to 400F are depicted to include a single size of powder particles 404, in some implementations, these operations can be implemented with multiple different sizes of powder particles. While some implementations of the AM apparatus described herein include two types of particles (e.g., the first and the second powder particles), in some cases, additional types of particles can be used. As described above, the first powder particles have a smaller size than the second powder particles. In some implementations, prior to dispensing the second powder particles to form a layer, the apparatus dispenses third powder particles onto the platen or underlying previously dispensed layer. This third powder particles can provide a thin layer onto which the first powder particles are dispensed. The third powder particles having a mean diameter that is at least two times smaller than the first mean diameter. This permits the second powder particles to settle into the layer of third particle particles. This technique can increase the density of the object at the bottom of the layer of second powder particles, e.g., if the first powder particles cannot infiltrate to the bottom of the layer of second powder particles.

While FIGS. 4A to 4F depict the enclosure region 432, the inner region 434, and the outer region 436 as remaining in substantially the same location with each layer of the object layers dispensed, in some cases, these regions vary in size and location. For example, the enclosure region 432 may move outwardly with each object layer dispensed, thus causing the enclosure 428 to slope outwardly as more object layers are dispensed. The enclosure 428 may slope outwardly because the object increases in area for layers that are dispensed later during the build operations. In some cases, the enclosure 428 may slope inwardly because the workpiece has a smaller area with subsequent object layers dispensed. The smaller inner region and larger outer region 436 in these cases may facilitate reclamation of greater quantities of the powder.

The processing conditions for additive manufacturing of metals and ceramics are significantly different than those for plastics. For example, in general, metals and ceramics require significantly higher processing temperatures. Thus 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

A number of implementations have been described. Nevertheless, it will be understood that various modifications may be made. For example,
The technique of fabricating the support plate can be performed without fabricating the posts underneath.
The enclosure can be fabricated directly on the build platform without fabricating the support plate underneath the object. Similarly, the support plate, with or without the posts, could be fabricated to support the object, but without fabricating the enclosure.
The support plate and/or enclosure can be fabricated on a support platen that does not include the apertures for powder reclamation.
The build platform described with reference to FIG. 1 could be used for fabrication of parts in an additive manufacturing system, but without fabricating the posts, support plate or enclosure.
Various components described above as being part of the printhead, such as the dispenser(s), spreader(s), sensing system(s), heat source and/or energy source, can be mounted on the gantry instead of in the printhead, or be mounted on the frame that supports the gantry.

Accordingly, other implementations are within the scope of the claims.

What is claimed is:

1. An additive manufacturing apparatus for forming an object, the additive manufacturing apparatus comprising:
a platform;
a dispensing system overlying the platform to dispense a plurality of successive layers of powder over a top surface of the platform, the plurality of successive layers comprising a plurality of object layers;
a energy source to fuse the powder dispensed on the top surface of the platform; and
a controller coupled to the dispensing system and the energy source and configured to cause the energy source to
fuse an enclosure region of each of the plurality of object layers to form an enclosure dividing each of the plurality of object layers into an inner region and outer region, and
fuse an object portion of the inner region of each of the plurality of object layers to form the object,
wherein a parallel projection of the object on the top surface of the platform defines a part area contained within the inner region.

2. The additive manufacturing apparatus of claim 1, wherein the inner region comprises an area at least 120% to 150% of the part area.

3. The additive manufacturing apparatus of claim 1, wherein a lateral dimension of the inner region is about 110% to 125% of a lateral dimension of the part area.

4. The additive manufacturing apparatus of claim 1, wherein a perimeter of the inner region is a substantially constant distance from a perimeter of the part area.

5. The additive manufacturing apparatus of claim 1, wherein the plurality of successive layers comprise a plurality of support layers and the plurality of object layers are disposed on the plurality of support layers, and wherein the controller is configured to fuse a support region of each of the plurality of support layers to form a part support base in which a top surface of the part support base supports a bottommost layer of the plurality of object layers.

6. The additive manufacturing apparatus of claim 5, wherein the enclosure is formed along a perimeter of the part support base.

7. The additive manufacturing apparatus of claim 5, wherein the controller is configured to cause the dispensing system to dispense the plurality of object layers over only the part support base.

8. The additive manufacturing apparatus of claim 1, wherein the platform comprises a plurality of holes configured to collect powder deposited outside the enclosure region.

9. A method for forming an object, the method comprising:
dispensing a plurality of successive layers of powder over a top surface a platform, the plurality of successive layers comprising a plurality of object layers;
fusing an enclosure region of each of the plurality of object layers to form an enclosure dividing each of the plurality of object layers into an inner region and outer region; and
fusing an object portion of the inner region of each of the plurality of object layers to form the object, wherein a projection of the object on the top surface of the platform defines a part area contained within the inner region.

10. The method of claim 9, wherein a perimeter of the inner region is a substantially constant distance from a perimeter of the part area.

11. The method of claim 9, wherein the plurality of layers comprise a plurality of support layers, and the plurality of object layers are disposed on the plurality of support layers, and the method comprises fusing a support region of each of the plurality of support layers to form a part support base in which a top surface of the part support base supports a bottommost layer of the plurality of object layers.

12. The method of claim 11, wherein the enclosure is formed along a perimeter of the part support base.

13. The method of claim 11, wherein the plurality of object layers are dispensed over only the part support base.

14. The method of claim 9, comprising collecting powder deposited outside the enclosure region.

15. An additive manufacturing apparatus for forming an object, the additive manufacturing apparatus comprising:
a platform;
a dispensing system overlying the platform to dispense a plurality of successive layers of powder over a top surface of the platform, the plurality of successive layers comprising a plurality of part support layers, and a plurality of object layers on the plurality of support layers;
a energy source to fuse the powder dispensed on the top surface of the platform; and
a controller coupled to the dispensing system and the energy source and configured to cause the energy source to
fuse a support region of each of the plurality of part support layers to form a part support base in which a top surface of the part support base supports a bottommost layer of the plurality of object layers, and
fuse an object region of each of the plurality of object layers to form the object.

16. The additive manufacturing apparatus of claim 15, wherein controller is configured to cause the dispensing system to dispense the plurality of object layers over only the part support base.

17. The additive manufacturing apparatus of claim 15, wherein the platform comprises a plurality of holes configured to collect powder deposited outside the part support base.

18. A method of forming an object by additive manufacturing, the method comprising:
dispensing a plurality of successive layers of powder over a top surface of a platform, the plurality of successive layers comprising a plurality of part support layers, and a plurality of object layers on the plurality of support layers;
fusing a support region of each of the plurality of part support layers to form a part support base in which a top surface of the part support base supports a bottommost layer of the plurality of object layers; and
fusing an object region of each of the plurality of object layers to form the object.

19. The method of claim 18, comprising dispensing the plurality of object layers over only the part support base.

20. The method of claim 18, comprising collecting powder deposited outside the part support base.

21. An additive manufacturing apparatus for forming an object, the additive manufacturing apparatus comprising:
a platform;
a dispensing system overlying the platform to dispense a plurality of successive layers of powder over a top surface of the platform, the plurality of successive layers comprising a plurality of post layers, and a plurality of object layers over the plurality of post layers;
a energy source to fuse the powder dispensed on the top surface of the platform; and
a controller coupled to the dispensing system and the energy source and configured to cause the energy source to
fuse a post region of each of the plurality of post layers to form a plurality of posts, and
fuse an object region of each of the plurality of object layers to form the object, and wherein the plurality of posts support the object such that a gap separates the object from the platform.

22. The additive manufacturing apparatus of claim 21, wherein the controller is configured to cause the energy source to fuse the post region such that the plurality of posts each comprise a height between 1 and 100 mm.

23. The additive manufacturing apparatus of claim 21, wherein the controller is configured to cause the energy source to fuse the post region such that the plurality of posts have a diameter of between 1 and 10 mm.

24. The additive manufacturing apparatus of claim 21, wherein the controller is configured to cause the energy source to fuse the post region such that the plurality of posts are spaced at a pitch between 1 and 10 cm.

25. The additive manufacturing apparatus of claim 21, wherein the controller is configured to cause the energy source to fuse the post region such that a support post of the plurality of posts comprises a vertical through-hole.

26. The additive manufacturing apparatus of claim 21, wherein the plurality of successive layers comprise a plurality of part support layers between the plurality of post layers and the plurality of object layers, and wherein the controller is configured to cause the energy source to fuse a support region of each of the plurality of part support layers to form a part support base in which a top surface of the part support base supports a bottommost layer of the plurality of object layers, and wherein the plurality of posts support a bottom surface of the part support base such that the gap separates the part support base from the platform.

27. A method of forming an object by additive manufacturing, the method comprising:
dispensing a plurality of successive layers of powder over a top surface of a platform, the plurality of successive layers comprising a plurality of post layers, and a plurality of object layers over the plurality of support layers;
fusing a post region of each of the plurality of post layers to form a plurality of posts; and
fusing an object region of each of the plurality of object layers to form the object,
wherein the plurality of posts support the object such that a gap separates the object from the platform.

28. The method of claim 27, comprising dispensing the plurality of object layers over only the part support base.

29. The method of claim 27, wherein:
a parallel projection of the object on the top surface of the platform defines a part area,
a parallel projection of the part support base on the top surface of the platform defines a support area, and
the support area comprises the part area.

30. The method of claim 27, wherein the plurality of successive layers comprise a plurality of part support layers between the plurality of post layers and the plurality of object layers, and comprising fusing a support region of each of the plurality of part support layers to form a part support base in which a top surface of the part support base supports a bottommost layer of the plurality of object layers, and wherein the plurality of posts support a bottom surface of the part support base such that the gap separates the part support base from the platform.
